(19) United States
(12) Patent Application Publication
(10) Pub. No.: US 2012/0048894 A1
(43) Pub. Date: Mar. 1, 2012

(54) HAND-OPERATED PUMP

(76) Inventors: Francis Tatu, Manlius, NY (US); David Young, Syracuse, NY (US)

(21) Appl. No.: 13/217,521

(22) Filed: Aug. 25, 2011

Related U.S. Application Data
(60) Provisional application No. 61/376,896, filed on Aug. 25, 2010.

(51) Int. Cl. B05C 17/01

(52) U.S. Cl. 222/382; 222/385; 222/1

(57) ABSTRACT

Disclosed in this specification is a hand-operated dispensing pump for dispensing viscous fluids. The container includes a flexible cap attached to the bottom portion of the container that defines a fluid pumping zone. An elongated tube extends from this zone to a spout that is disposed atop the container. The cap is equipped with at least two one-way valves that selectively permit fluid to pass into the pumping zone when the cap flexes in a first direction and permits fluid to pass out of the pumping zone and out the spout when the cap flexes in a second direction.

### CROSS-REFERENCE TO RELATED APPLICATIONS

This application claims priority to and the benefit of co-pending U.S. provisional patent application Ser. No. 61/376,896, filed Aug. 25, 2010, which application is incorporated herein by reference in its entirety.

### FIELD OF THE INVENTION

This invention relates, in one embodiment, to a hand-operated pump for dispensing viscous fluids such as hand creams, lotions, soaps, shampoos, conditions, polishes, cleaners and the like.

### BACKGROUND

Conventional hand-operated pumps are widely used in household products such as hand-lotion containers, soap dispensers and the like. These pumps generally place the pumping mechanism within the cap. An elongated tube extends from the cap and terminates in an open end. The open end is placed within the liquid to be dispensed. As the pump is manually operated, the fluid passes through the open end of the tube, through the pump and is dispensed to the user. Unfortunately, these conventional hand-pumps suffer from a number of shortcomings.

To properly function, a multitude of components must be used to construct the pump. Current hand-pumps often need many individual components. These components must be made of various types of materials, not all of which are recyclable. Additionally, the tube must remain a certain distance away from the bottom of the container or the end of the tube will clog. This often results in a residual amount of liquid being left in the container which cannot be removed by the pump.

It is therefore desirable to provide a new hand-operated pump that addresses at least some of these shortcomings.

### SUMMARY OF THE INVENTION

The invention comprises, in one form thereof, a hand-operated dispensing pump for dispensing viscous fluids. The container includes a flexible cap attached to the bottom portion of the container that defines a fluid pumping zone. An elongated tube extends from this zone to a spout that is disposed atop the container. The cap is equipped with at least two one-way valves that selectively permit fluid to pass into the pumping zone when the cap flexes in a first direction and permits fluid to pass out of the pumping zone and out the spout when the cap flexes in a second direction.

An advantage of the present invention is the pump requires fewer parts and is thus less costly to manufacture. The components are mechanically simple which permits all components to be made of plastic, thus making the entire container fully recyclable and easy to form using only injection molding or extrusion techniques. The container also uses a larger amount of residual liquid and is therefore more efficient.

### BRIEF DESCRIPTION OF THE DRAWINGS

The present invention is disclosed with reference to the accompanying drawings, wherein:

FIG. 1 is a profile view of a bisected container of the invention;

FIG. 2A and FIG. 2B are close-up views of the bottom of the container of FIG. 1 from two different views;

FIG. 3A is a perspective view of the bottom portion of the container of FIG. 1 while FIG. 3B is a top view of the same bottom portion;

FIG. 3C and FIG. 3D are top and bottom views of one cap of the invention;

FIG. 4A is a close-up view of the bottom of the container of FIG. 1;

FIG. 4B and FIG. 4C are depictions of the flexing motion of the cap during use;

FIG. 5 is a close-up view of the bottom of the container of FIG. 1 showing the path of fluid flowing out of the container;

FIG. 6 is a close-up view of the bottom of the container of FIG. 1 showing the replenishment path of fluid flowing into the pumping zone;

FIG. 7 is a close-up view of the top of the container of FIG. 1;

FIG. 8A and FIG. 8B are perspective views of the top of the container with the spout removed and with the spout attached, respectively; and

FIG. 9 is a close-up bottom view of another bisected container of the invention; and

FIGS. 10A and 10B are schematic side-views of another embodiment of the invention.

Corresponding reference characters indicate corresponding parts throughout the several views. The examples set out herein illustrate several embodiments of the invention but should not be construed as limiting the scope of the invention in any manner.

### DETAILED DESCRIPTION

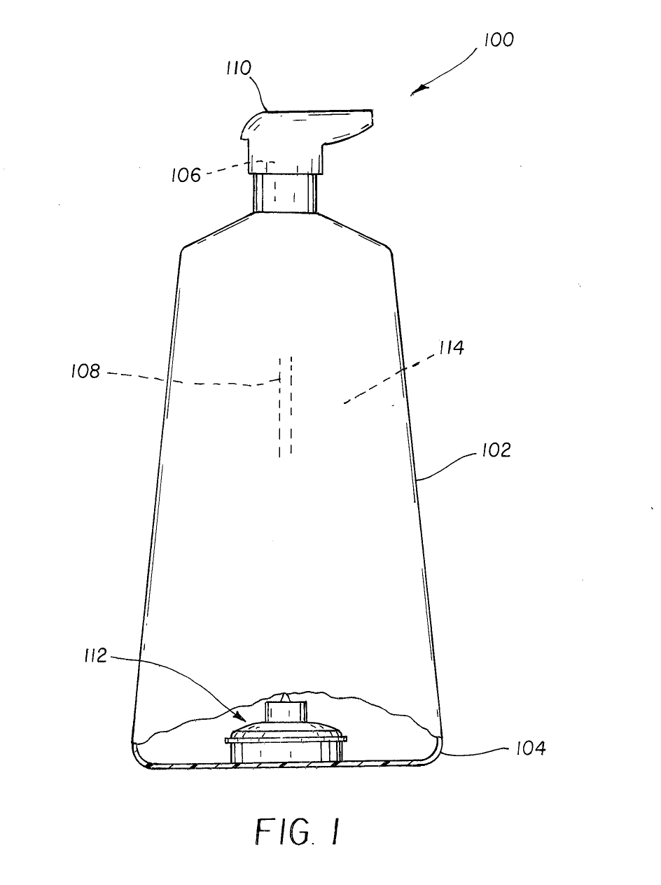

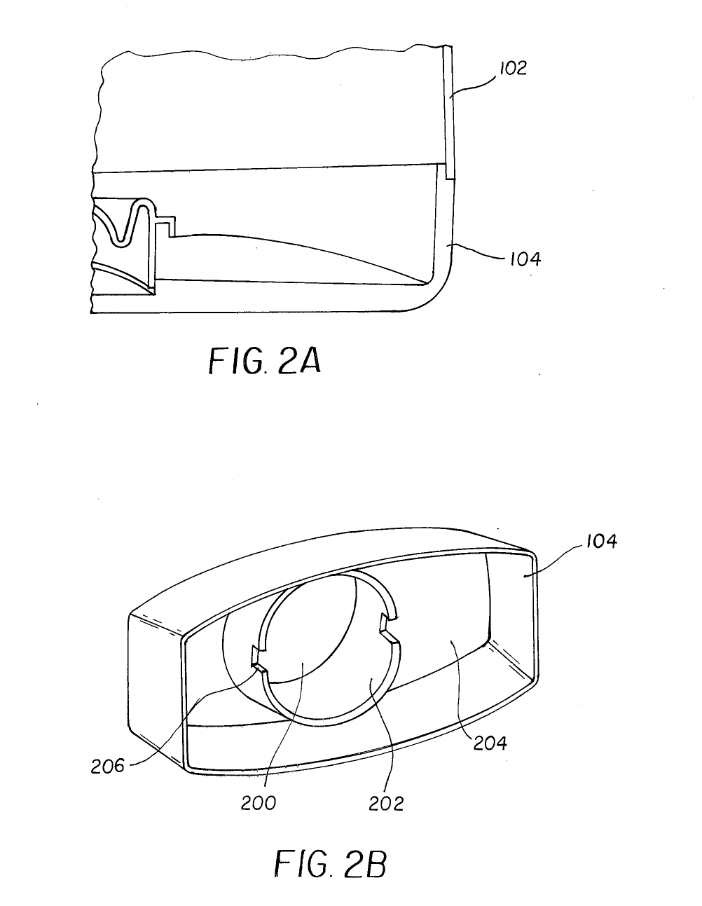

FIG. 1 is a depiction of container 100. Container 100 is show as a bisected view to better depict the internal components of the container. Container 100 includes an upper portion 102 and a lower portion 104. In the embodiment of FIG. 1, these two portions are discrete units. In one embodiment, both portions are formed from rigid (e.g. minimally flexible during ordinary use) plastic. Upper portion 102 includes a bore 106 at the top end of the container 100. Also shown in FIG. 1 is elongated tube 108 whose first end extends through bore 106 and terminates in spout 110. The second end of tube 108 terminates at flexible cap 112. In one embodiment, upper portion 102 and lower portion 104 are discrete components that are connected to one another by an induction seal (FIG. 2A). The pump is designed to store a viscous liquid in space 114 and extrude a portion of this liquid through spout 110 upon depression of the spout and the flexing of cap 112. The configuration of cap 112 is described below.

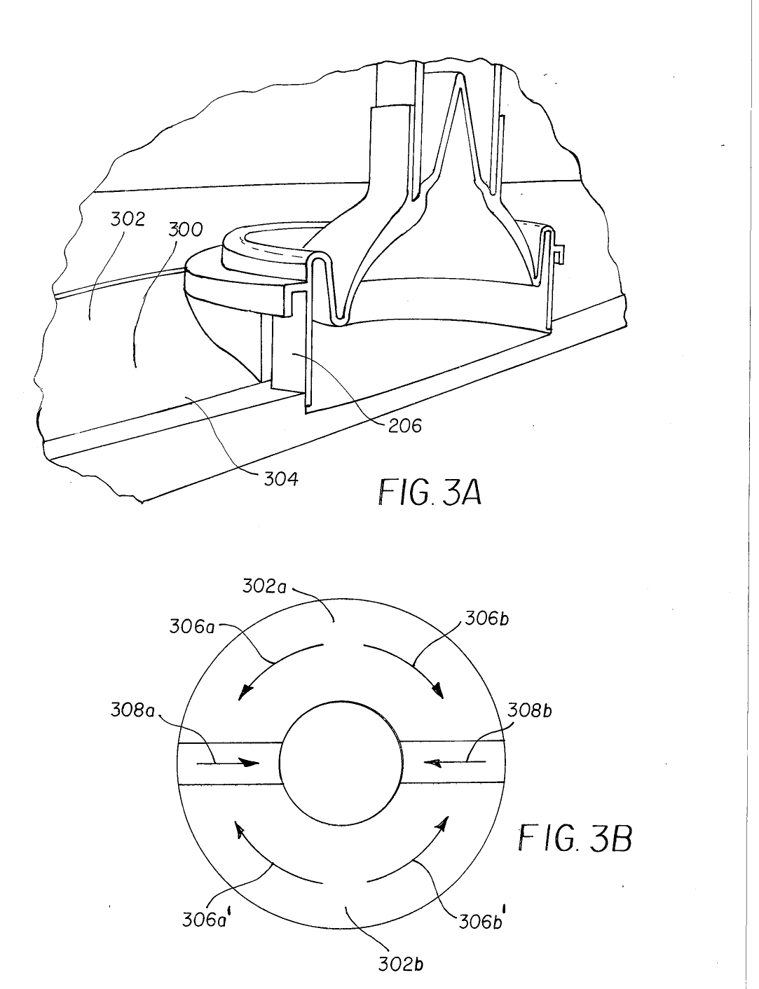

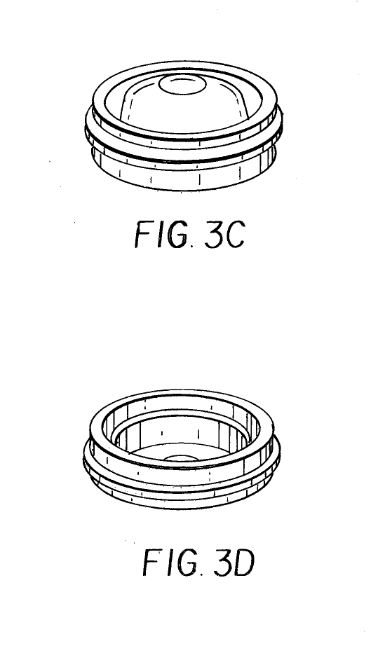

FIG. 2B is a perspective view of lower portion 104. Lower portion 104 includes a cap-receiving member 200. Cap-receiving member 200 includes wall 202 that extends perpendicular to the surface 204 of the lower portion 104. Wall 202 has at least one opening 206. Cap-receiving member 200 and cap 112 are configured to securely mate with one another as shown in FIG. 3A. In the embodiment of FIG. 2B, walls 202 define a circular cap-receiving member. Other suitable shapes are also possible. In one embodiment, lower portion 104 is contoured to cause the vicious liquid in space 114 to be directed toward opening 206.

As shown in FIG. 3A and FIG. 3B, lower portion 104 includes contour 300 that has downwardly sloping sections that exists between high points 302a, 302b and trench 304a, 304b. These sloping sections drive the fluid in space 114 in the direction of arrows 300a, 300a′, 300b, 300b′ toward trenches 304a, 304b when the container is in an upright position. In this fashion, lower portion 104 provides a means to guide fluid toward the opening 206. Trenches 304a and 304b, in turn, slopes downward in the direction of arrows 308a and 308b, respectively, and terminate at the respective opening 206 of the cap-receiving member 200. As the fluid is consumed, this trench guides residual fluid down this slope and toward opening 206, thus minimizing the amount of wasted fluid due to unintentional entrapment at the bottom of the container 100. Although two trenches are shown in the figures, other embodiments have only one trench and the slopes of contour 300 is adjusted to cause the fluid to flow toward this single trench. In other embodiment, more than two trenches are used and contour 300 is similarly adjusted. The trenches illustrated in the figures have walled edges. In other embodiments, not shown, the edges of the trench are gradually sloped and do not have an abrupt edge.

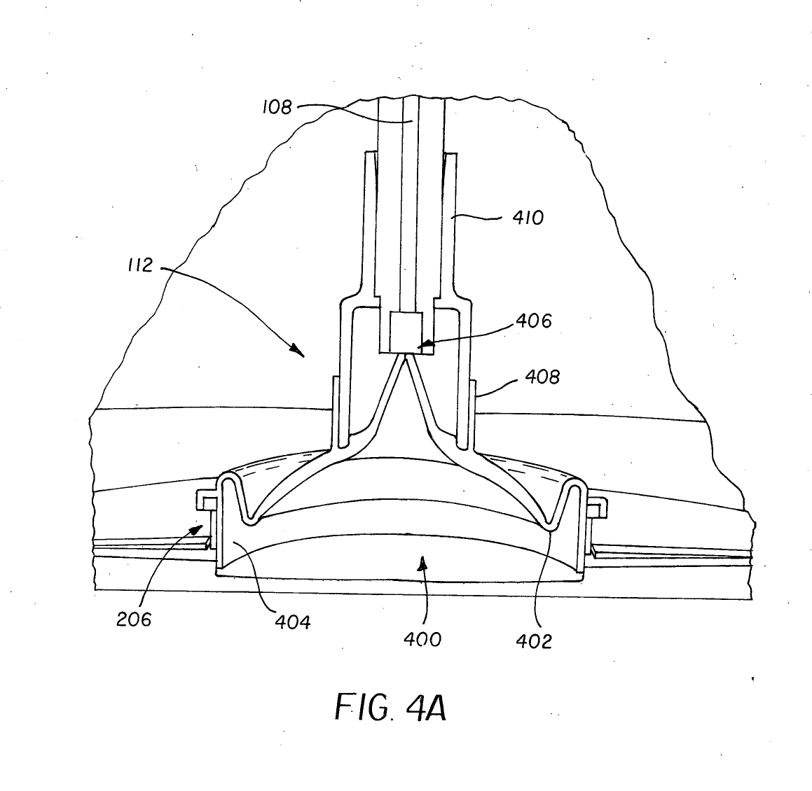

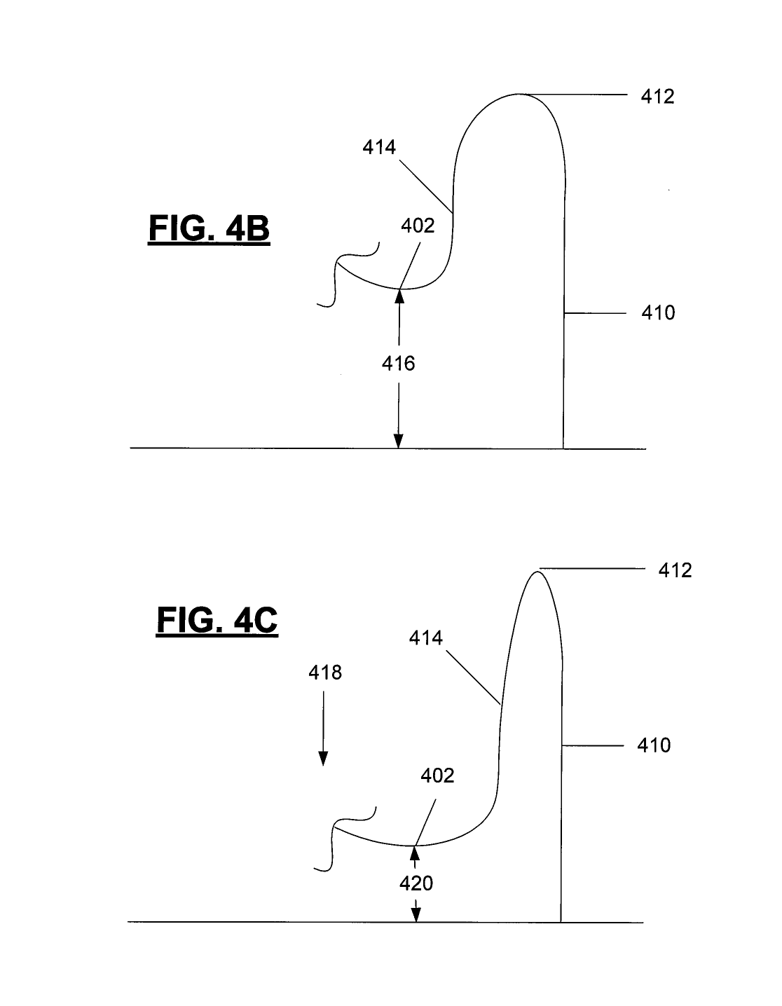

FIG. 3C and FIG. 3D are top and bottom views, respectively, of flexible cap 112. A more detailed, bisected view of cap 112 is shown in FIG. 4A.

As shown in FIG. 4A, cap 112, when mated with cap-receiving member 200, defines a pumping zone 400. During operation, fluid from space 114 is drawn into pumping zone 400. This fluid is eventually dispensed from stem 110. Cap 112 is configured to flex at point 402. In other embodiments, different dome and hinge configurations are used. A first one-way valve 404 disposed over the opening 206 in the cap-receiving member for permitting fluid to be drawn into the pumping zone. A second one-way valve 406 is also provided for permitting fluid to be drawn out of the pumping zone and delivered through the tube 108. In the embodiment of FIG. 4A, one-way valve 406 is a “duck bill” valve. Other suitable one-way values would be apparent to those skilled in the art after benefitting from reading this specification. Cap 112 includes a connector 408 for securely connecting to tube 108. In some embodiments, a separate adaptor 410 assists in making this connection.

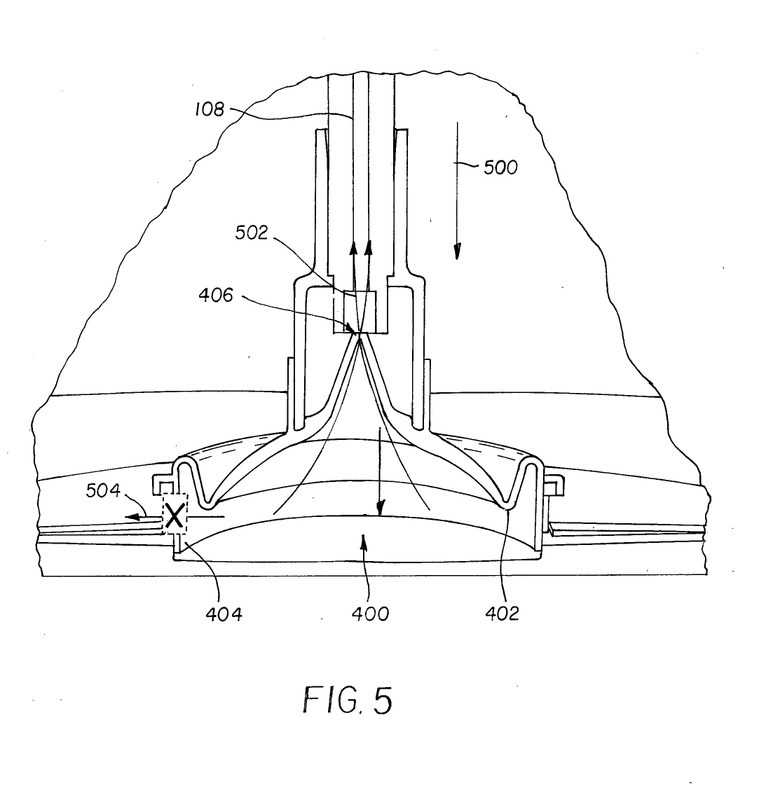

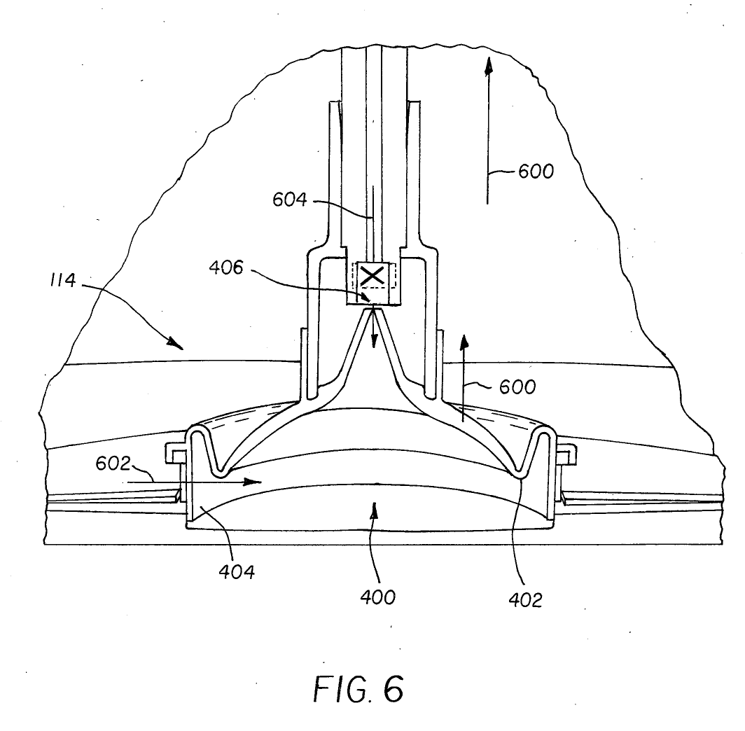

FIG. 4B and FIG. 4C are close-up views of flexible cap 112 in use. In other embodiments some different dome and hinge configurations are used. Flexible cap 112 includes an outer vertical wall 410 that extends upwardly, a curved portion 412 that transitions to downwardly extending wall 414. In FIG. 4B, the flexible cap is in a pre-depressed state. No force is being applied. The volume of the pumping zone 400 is related to the distance 416 between the surface of cap-receiving member 200 and the top of the cap 112. In FIG. 4C, the flexible cap is in a depressed state. A force is being applied in the direction of arrow 418. This causes the cap to bend at several points, including point 402 and thereby reduce the volume of pumping zone 400. The volume of the pumping zone 400 is related to the reduced distance 420. This reduction in volume causes fluid that resides within the pumping zone to be extruded through spout 110. The details of this extrusion are shown in FIG. 5 and FIG. 6. One skilled in the art would recognize the total volume of the pumping zone is proportional to the distance between the top of the dome and the base, but points 416 and 420 are depicted for clarity.

As shown in FIG. 5 when the spout (not shown) is depressed downward by applying a force, the tube 108 moves in the direction of arrow 500 which causes the cap 112 to move likewise, flexing at point 402 and reducing the volume of zone 400. One-way valve 404 prevents any fluids that are disposed within zone 400 from moving in the direction of arrow 504. The fluid within zone 400 escapes through one-way valve 406 in the direction of arrow 502. This escaped fluid travels through the elongated tube 108 and is eventually is dispensed through the spout 100.

Referring to FIG. 6, when the downward force that was applied to the spout is released, the cap returns to its natural position which moves the top of the cap direction of arrow 600. This increases the volume of zone 400 and causes fluid to flow from space 114, through one-way valve 404 in the direction of arrow 602. Fluid is prevented from flowing out of the tube 108 in the direction of arrow 604 by one-way valve 406. In this fashion, zone 400 is replenished with additional fluid. By adjusting the configuration of the cap, and particularly the rigidity point 402, the amount of force required to flex the cap can be controlled. In one embodiment, the cap requires a force of approximately 22 N to fully depress.

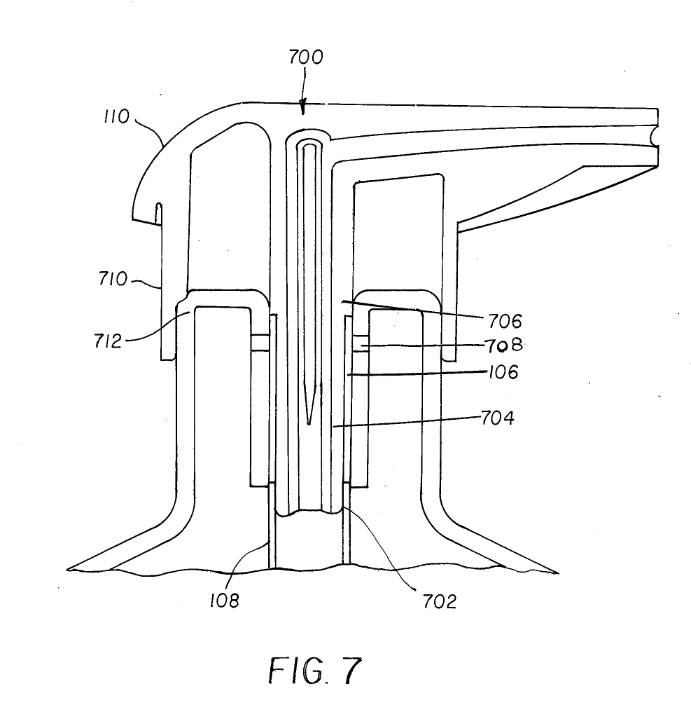

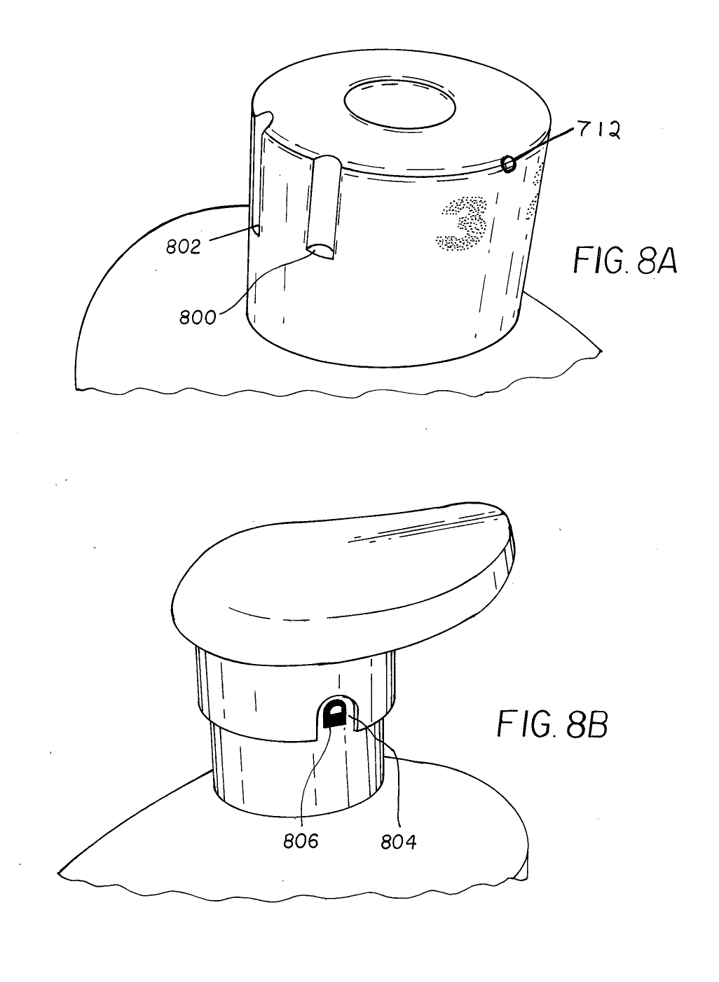

As shown in FIG. 7, spout 110 passes through bore 106 and connects to tube 108. Spout 110 includes an elongated stem 700 that has a wide barb end 702, a narrower central portion 704, and a wide cap end 706. Barb end 702 is slightly larger than the diameter of the bore 106 and prevents accidental disassembly of the container. Cap end 706 is configured to be disposed over vents 708 of bore 106. Cap end 706 includes a series of alternating curved and flat surfaces (not shown) about its perimeter. When the spout 110 is in a locked position, a curved surface fits over vents 708, thereby locking the vents closed. Such a configuration prevents contamination while the container 100 is being stored. When spout 110 is in an unlocked position, a fiat surface fits over vents 708, thereby providing a pathway for air to flow through the vents. Spout 110 also has an internal notch 710 that engages a corresponding dimple 712 on the top surface of upper portion 102. The alignment of the curved and flat surfaces is controlled by alignment of the notch and dimples. FIG. 8A illustrates an embodiment which includes a plurality of dimples, some of which are elongate.

FIG. 8A depicts shallow dimple 712 as well as elongated dimples 800 and 802. Notch 710 is configured to rest on dimple 712 (which prevents spout 110 from being depressed) or slide within elongated dimples 800 or 802 until the notch rests at the bottom portion of the dimple. The longer the depth of the elongated dimple, the further the spout 110 can be depressed and the more fluid is dispensed. Embodiment such as those depicted in FIG. 8A provide dimples with various depths and thereby permit various volumes of fluid to be dispensed or, alternatively, provide a lock for the container to prevent the spout from being depressed.

FIG. 8B depicts another embodiment where the spout 110 includes a window 804 that permits the user to view an indicator 806. In such an embodiment a plurality of indicators are disposed in a circle on the surface of the upper portion 102 such that only one such indicator is visible through the window 804 at a time. As the spout is rotated, notch 710 engages different dimples (712, 800, 802, etc.) and a different indicator becomes visible that corresponds to the different dimple. Indicator 806 appears as a lock to indicate dimple 712 that locks the spout. FIG. 8A shows indicators “2” and “3” that correspond to larger volumes of dispensing fluid being released. Three dimples are visible in FIG. 8A but any suitable number of indicators may be used.

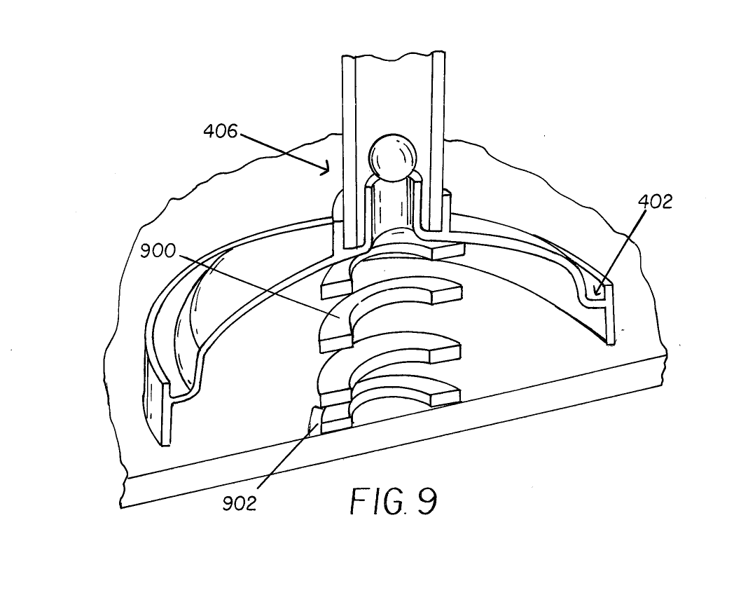

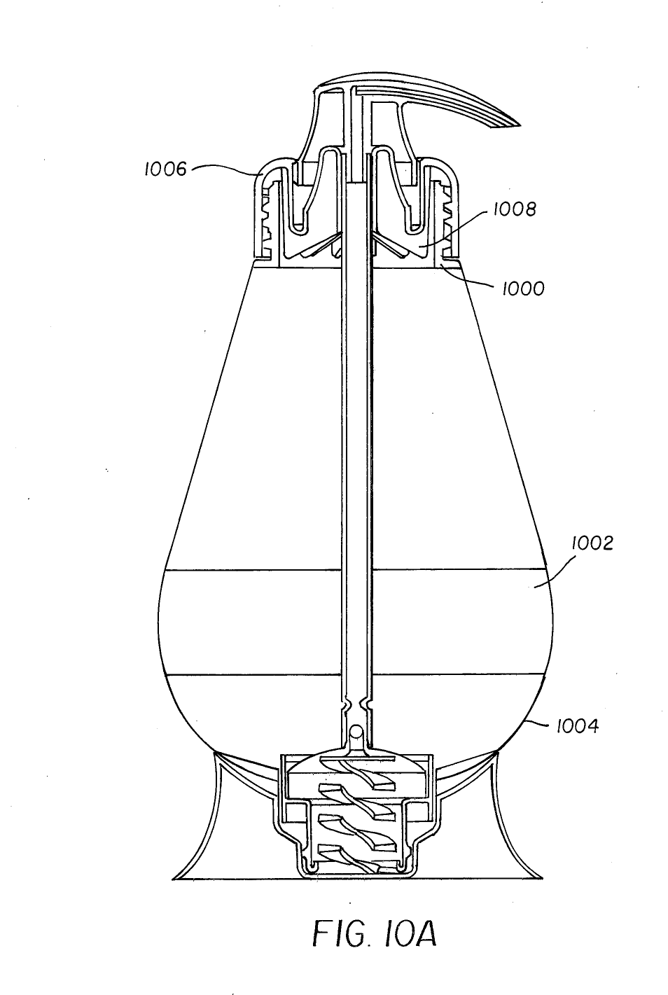

FIG. 9 is a depiction of another embodiment. The embodiment of FIG. 9 differs from that of FIG. 5 in that the one-way valve 406 is a ball valve with a stop. The embodiment also differs in that a spring 900 is provided to aid in returning cap 112 to its natural position. This permits the curve of flex point 402 to include fewer bends. Spring 900 attaches to lower portion 104 at mount 902 which, in the embodiment illustrated, is a recess in the bottom of power portion 104 sized to receive spring 900. Since the view of FIG. 9 is a bisected view, only half of the spring is shown.

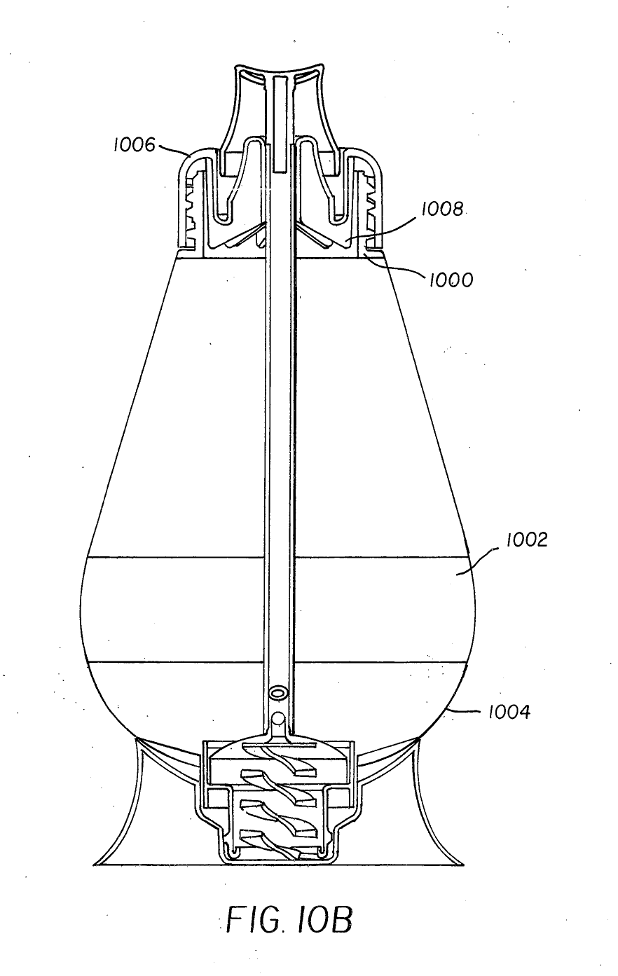

FIGS. 10A and 10B are two views of another embodiment of the invention. The container displayed includes upper portion 1000 and lower portion 1002. Lower portion 1002 includes contoured surface 1004 that cause the vicious liquid to be directed toward the opening in the cap-receiving member. Upper portion 1000 is connected to collar 1006 but may be separated therefrom by, for example, a screw connection or other conventional means. Collar 1006 includes lead-in guides 1008. When the container is depleted, the collar 1006 and its spout are seprated from upper portion 1006 while leaving the stem connected to lower portion 1004. The container may then be refilled with additional liquid. When the collar 1006 and upper portion 1000 are reassembled, lead-in guides 1008 act to guide the elongated stem into position such that it properly connects to the spout. The lead-in guides 1008 provide a generally conical surface that guides the stem toward the vertex of the cone which coincides with the desired location of the stem.

The aforementioned containers and components are preferably constructed from durable plastics. Examples include polypropylene and polyethylene. Advantageously, this permits the components to be formed by injection molding or extrusion methods. For the purposes of explaining the invention, FIGS. 1-9 generally referred to only a single container shape but it should be recognized that many other container shapes can also be used.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A hand-operated dispensing pump for dispensing viscous fluids comprising
a container for holding a viscous fluid that includes an upper portion and a lower portion that encase a space;
the upper portion providing a bore at a top end of the container;
the lower portion having a cap-receiving member that includes at least one opening;
a flexible cap disposed on the cap-receiving member, thereby defining a fluid pumping zone encased by the cap-receiving member and the cap, the cap providing a first one-way valve disposed over the opening in the cap-receiving member for permitting fluid to be drawn into the pumping zone and a second one-way valve for permitting fluid to be drawn out of the pumping zone; and
an elongated tube extending from the second one-way valve of the cap through the bore of the upper portion and terminating in a spout at the upper portion of the container.

2. The pump as recited in claim 1, wherein the lower portion is connected to the upper portion by an induction seal.

3. The pump as recited in claim 1, wherein the lower portion includes means for guiding fluid into the opening of the cap-receiving member.

4. The pump as recited in claim 1, wherein the upper portion includes at least one vent connected to the space encased by the upper portion and the lower portion.

5. The pump as recited in claim 4, wherein the spout includes an elongated stem with a cap end, a barbed end and a central portion that is narrower than the cap end and the barbed end, the barbed end and the cap end being connected to one another by the central portion.

6. The pump as recited in claim 4, wherein the spout includes an elongated stem with a cap end and a central portion that is narrower than the cap end.

7. The pump as recited in claim 6, wherein cap end includes a flat surface adjacent a curved surface, each of which are proximal the vent; the vent being unobstructed when the flat surface is aligned with the vent and obstructed when the curved surface is aligned with the vent.

8. The pump as recited in claim 1, wherein spout is rotatably engaged to the bore and the upper portion includes a first dimple on its outer surface proximate to the bore, the first dimple having a first depth.

9. The pump as recited in claim 8, wherein the upper portion includes a second dimple on the outer surface of the upper portion, the second dimple having a second depth and being disposed proximate to the first dimple, the second depth being greater than the first depth.

10. The pump as recited in claim 9, wherein the spout includes at least one notch on its internal surface that engages the first dimple when the spout is rotated to a first position and engages and slides within the second dimple when the spout is rotated to a second position.

11. The pump as recited in claim 10, wherein the upper portion includes a third dimple on the outer surface of the upper portion, the third dimple having a third depth and being disposed proximate to the second dimple, the third depth being greater than each of the first depth and the second depth, wherein the notch of the spout engages and slides within the third dimple when the spout is rotated to a third position.

12. The pump as recited in claim 1, wherein the upper portion, the lower portion, the cap-receiving member, flexible, the first one-way, the second one-way valve, the elongated tube and the spout are each plastic.

13. The pump as recited in claim 1, further including a spring disposed within the pumping zone, the spring connected to the lower portion at a first end and to the flexible cap at a second end.

14. The pump as recited in claim 13, wherein the spring is plastic.

15. The pump as recited in claim 1, wherein the first one-way valve is a flap valve.

16. The pump as recited in claim 1, wherein the second one-way valve is selected from the group consisting of a duck bill valve and a ball valve.

17. The pump as recited in claim 1, wherein upper portion and lower portion are unitary and the lower portion includes a downwardly contoured surface that guides viscous fluid toward the opening.

18. The pump as recited in claim 1, further comprising a collar connected to the spout and to the upper portion, wherein the collar is separable from the upper portion while leaving the elongated tube connected to the lower portion.

19. The pump as recited in claim 18, wherein the collar includes lead-in guides to direct the elongated tube during reassembly of the collar and upper portion after refilling the pump.

20. A hand-operated dispensing pump for dispensing viscous fluids comprising
a container for holding a viscous fluid that includes an upper portion and a lower portion that encase a space;
the upper portion providing a bore at a top end of the container;
the lower portion having a cap-receiving member that includes at least one opening, the lower portion further including:
at least one downwardly sloping trench whose downward end terminates at the opening of the cap-receiving member;
the lower portion further including a downwardly contoured surface whose downward section is adjacent the downwardly sloping trench;
a flexible cap disposed on the cap-receiving member, thereby defining a fluid pumping zone encased by the cap-receiving member and the cap, the cap providing a first one-way valve disposed over the opening in the cap-receiving member for permitting fluid to be drawn into the pumping zone and a second one-way valve for permitting fluid to be drawn out of the pumping zone; and
an elongated tube extending from the second one-way valve of the cap through the bore of the upper portion and terminating in a spout at the upper portion of the container.

21. The pump as recited in claim 20, wherein the first one-way valve is a flap valve and the second one-way valve is selected from the group consisting of a duck bill valve and a ball valve.

22. A method for pumping viscous fluids using a hand-operated dispensing pump comprising the steps of:
providing a pump as recited in claim 1;
depressing the spout and thereby causing the elongated tube to move downward and apply a force to the flexible cap;
flexing the flexible cap in response to the force, thereby compressing the pumping zone and reducing its volume;
extruding fluid from the compressed pumping zone through the second one-way valve, the extruded fluid passing through the elongated tube and out of the spout;
ceasing the depression of the spout and thereby removing the force that was applied to the flexible cap and permitting the flexible cap to return to its pre-depressed state which, in turn, returns the elongated tube and spout to their pre-depressed state;
decompressing the pumping zone through the return of the flexible cap to its pre-pressed state, thereby increasing the pumping zone's volume;
pulling fluid from the space encased by the upper and lower portion, through the first one-way valve, and into the pumping zone, thereby replenishing the pumping zone with fluid.
